(19) United States
(12) Patent Application Publication
(10) Pub. No.: US 2013/0217936 A1
(43) Pub. Date: Aug. 22, 2013

(54) Method of Making Catalyst, Catalyst Made Thereby and Use Thereof

(71) Applicants: Jane C. Cheng, Bridgewater, NJ (US); Doron Levin, Highland Park, NJ (US)

(72) Inventors: Jane C. Cheng, Bridgewater, NJ (US); Doron Levin, Highland Park, NJ (US)

(73) Assignee: ExxonMobil Chemical Patents Inc., Baytown, TX (US)

(21) Appl. No.: 13/750,176

(22) Filed: Jan. 25, 2013

Related U.S. Application Data
(60) Provisional application No. 61/599,730, filed on Feb. 16, 2012.

(51) Int. Cl. B01J 29/44

(52) U.S. Cl. CPC B01J 29/44
USPC 585/321; 422/630; 423/713; 502/74; 502/68; 502/71; 502/62

(57) ABSTRACT

The invention concerns a method of making a catalyst adapted for isomerization of xylenes.

### PRIORITY CLAIM

This application claims the benefit of Provisional Application No. 61/599,730, filed Feb. 16, 2012, the disclosure of which is incorporated by reference in its entirety.

### FIELD OF THE INVENTION

The invention relates to a method of making a catalyst, the catalyst made thereby, and the use thereof, particularly the use in ethylbenzene dealkylation and/or xylene isomerization systems.

### BACKGROUND OF THE INVENTION

Paraxylene is used as the main raw material for polyester fibers and is relatively high value as compared with the other C8 aromatic isomers. Typically a C8 aromatic stream comprising ethylbenzene and xylenes is processed through a paraxylene recovery stage, such as an adsorption process (e.g., a Parex™ or Eluxyl™ adsorptive separation unit) or crystallization process, to recover a paraxylene-enriched stream and a paraxylene-depleted stream. The paraxylene-depleted stream can then be isomerized to equilibrium and recycled in the process for paraxylene recovery. This can be done commercially by dealkylation of ethylbenzene and isomerization of xylenes, often in two separate stages so that the catalyst can be optimized for each function. The typical commercial catalyst is based on a zeolite such as ZSM-5 and includes at least one metal serving the function of hydrogenation, typically selected from Group 8-10 (formerly “Group VIII”) of the Periodic Table, e.g., platinum. It is an expensive and difficult catalyst to manufacture and because of its importance to commerce the method of making such catalysts is an active area of research. Such catalysts are often used in other refinery and chemical plant operations such as transalkylation processes.

One advance in the past few years is to disperse a very low amount of the Group 8-10 metal. It has been found that highly dispersed metal mitigates aromatics saturation while maintaining high ethylene saturation, unfortunately sometimes at the expense of increased metal migration and/or increased susceptibility to poisons in the feed. It is also challenging to manufacture such a catalyst due to subtleties in dispersing highly valuable metals.

Recent prior art includes U.S. Pat. Nos. 6,008,425; 6,028,238; 7,247,762; 7,270,792; 7,271,118; 7,626,065; U.S. Publication 2011-0190556; and U.S. application Ser. No. 13/081351.

The present inventors have noted that one of the problems encountered in synthesis of the prior art catalysts is a rapid pH change during competitive ion exchange and surprisingly discovered a method of manufacture of these catalyst systems that provides a simple and elegant way of avoiding this and other prior art problems.

### SUMMARY OF THE INVENTION

The invention is directed to a method of manufacturing a metal-containing zeolite catalyst, preferably wherein the metal is selected from at least one of Groups 8-10 of the Periodic Table, preferably wherein the catalyst comprises a zeolite such as ZSM-5 or ZSM-11, wherein the improvement in catalyst manufacture comprises preparation of the metal-containing zeolite catalyst by competitive ion exchange in the presence of ammonium acetate. The invention also is directed to the catalyst made by said method and to the use of said catalyst in a process adapted for the production of paraxylene, preferably wherein the process comprises the production of equilibrium or near-equilibrium xylenes from a paraxylene-depleted feedstream.

In embodiments the resultant catalyst comprises a platinum-containing zeolite selected from ZSM-5, ZSM-11, ZSM-12, ZSM-18, mordenite, Beta, MCM-68, MCM-22, and mixtures thereof.

One of the advantages of the process of the invention is the achievement of highly dispersed metals on said zeolite, and thus in embodiments the resultant catalyst can be characterized as including at least one of a metal selected from Groups 8-10 of the Periodic Table, and preferably selected from one of platinum and rhenium, dispersed in the amount of from 0.01 wt % to 1.20 wt %, preferably 0.01 wt % to less than 1.00 wt %, more preferably 0.01 wt % to 0.50 wt %, based on the weight of said metal-containing zeolite.

It is an object of the invention to provide a method of manufacturing a metal-containing zeolite catalyst wherein the metal is highly dispersed, said process avoiding difficulties in the prior art such as rapid pH drop during competitive ion-exchange.

These and other objects, features, and advantages will become apparent as reference is made to the following detailed description, preferred embodiments, examples, and appended claims.

### DETAILED DESCRIPTION

In order to better understand the invention, reference will now be made to specific examples, which nevertheless are intended to merely be representative of the present invention and should not be taken as limiting.

A typical commercial catalyst for isomerization of a C8 aromatic feed is prepared, comprising a first bed adapted for ethylbenzene dealkylation and a second bed adapted for isomerization of a paraxylene-depleted xylene mixture to equilibrium mixture (e.g., about 24 mol % paraxylene based on the amount of xylenes present at ordinary processing conditions), by competitive ion exchange. Competitive ion exchange is per se well-known in the art. It is nevertheless challenging to those even of skill in the art to manufacture, and the present inventors have noted that there is a rapid pH change during the competitive ion exchange of H-ZSM-5 (or H-ZSM-11) catalyst in the presence of NH₄NO₃ during the incorporation of the metal of interest, e.g., platinum. The bulk of the ion-exchange reaction is shown below. The release of nitric acid (pKa=−1.4) causes this pH drop which is hard to neutralize quickly and thoroughly in a large scale and could cause corrosion of manufacturing equipment.

H-ZSM-5+NH₄NO₃→NH₄-ZSM-5+HNO₃

To mitigate the pH issue, several options were explored. The present inventors have found that the most effective option is to replace NH₄NO₃ with NH₄Ac (ammonium acetate) as shown below. Since the released acetic acid (HAc, pKa=4.75) is a much weaker acid, the pH of the exchange solution was easily maintained between 6.0-6.5 pH.

H-ZSM-5+NH₄Ac→NH₄-ZSM-5+HAc

The catalysts prepared with the NH₄Ac were compared with catalysts made with NH₄NO₃ in a fixed-bed micro unit. The two catalysts had comparable performance for EB conversion and xylene isomerization. Although only platinum on ZSM-5 is specifically illustrated, one of the advantages of the present invention is that it is applicable to a wider variety of catalysts, particularly Group 8-10 metals on a wider variety of molecular sieves, particularly ZSM-11, ZSM-12, ZSM-18, mordenite, Beta, MCM-68, MCM-22, as would be appreciated by one of ordinary skill in the art in possession of the present disclosure.

### EXAMPLE 1

### Preparation of First Bed Catalyst with Ammonium Nitrate Salt

195 g of H-ZSM-5 catalyst ( 1/16″ cylindrical extrudate with 65% ZSM-5 and 35% silica binder, previously 3 times selectivated by silicone treatment to reduce surface acidity, was added to a 500 cc glass column. Selectivation with silicone (and other agents) is per se well-known in the art. The ZSM-5 crystal had a SiO₂/Al₂O₃ molar ratio of 26:1. The catalyst was then humidified with wet air. An exchange solution made with 462 cc of 1 N NH₄NO₃ solution and 961 cc of de-ionized (DI) water was introduced to the column from a solution reservoir. A circulation rate of 130 cc/min was established for the ion-exchange. A rapid pH drop of the exchange solution was observed within the first 60 seconds from the initial pH of 6.17 to a pH of 1.80. A 10% NH₄OH solution was used to adjust pH to 6.0-6.5 during the circulation until the pH is steady. The circulation continued for 2 hours with occasional addition of NH₄OH solution to keep pH between 6.0-6.5. A second solution containing 2.32 g of tetraammine platinum nitrate solution (an aqueous solution with 3.55 wt % Pt) and 250 cc of DI water was introduced to the solution reservoir over three hours. The circulation continued for two days. The same 10% NH₄OH solution was used occasionally to keep pH between 6.0-6.5 during the 2-day circulation. The exchange solution was drained at the end of the two days, and the catalyst was rinsed with 3.4 liters of DI water and blow-dried with air at room temperature. The catalyst was calcined at 750° F. for 8 hours with a mixture of 40% air and 60% nitrogen. The final catalyst had a Pt content of 0.03% by weight. The catalyst evaluation is described in Example 5.

### EXAMPLE 2

### Preparation of Second Bed Catalyst with Ammonium Nitrate Salt

90 g of H-ZSM-5 catalyst ( 1/16″ cylindrical extrudate with 80% ZSM-5 and 20% silica binder) was added to a 500-cc glass column. The ZSM-5 crystal had a SiO₂/Al₂O₃ molar ratio of 70:1. The catalyst was humidified with wet air. An exchange solution made with 188 cc of 1 N NH₄NO₃ solution and 724 cc of de-ionized (DI) water was introduced to the column from a solution reservoir. A circulation rate of 85 cc/min was established for the ion-exchange. The pH dropped from the initial 6.11 to 2.80 in 4 min. A 10% NH₄OH solution was used to keep pH between 8.0-8.5 during the exchange. The circulation continued for 2 hours. A second solution containing 0.369 g of tetraammine platinum nitrate solution (an aqueous solution with 3.55 wt % Pt) and 160 cc of DI water was introduced to the solution reservoir over three hours. The circulation continued for 2 days. The same 10% NH₄OH solution was used occasionally to keep pH between 8.0-8.5 during the 2-day circulation. The exchange solution was drained at the end of the two days, and the catalyst was rinsed with 2.2 liter of DI water and blow-dried with air at room temperature. The catalyst was calcined at 750° F. for 8 hours with a mixture of 40% air and 60% nitrogen. The final catalyst had a Pt content of 0.01% by weight. The catalyst evaluation is described in Example 5.

### EXAMPLE 3

### Preparation of First Bed Catalyst with Ammonium Acetate Salt

The same procedure described in Example 1 was used to prepare the catalyst except that the exchange solution was made with ammonium acetate salt (35.61 g of solid, chemical grade ammonium acetate and 1423 cc DI water, initial pH was 7.01). No rapid drop in pH was observed when the ammonium acetate exchange solution was used. The observed pH of the exchange solution was 6.2 after 5 minutes. When pH dropped below 6.0, the same 10% NH₄OH solution was used to keep pH between 6.0-6.5. The amount of 10% NH₄OH solution required to adjust pH was significantly less when compared with Example 1. The final catalyst had a Pt content of 0.03% by weight. The catalyst evaluation is described in Example 6.

### EXAMPLE 4

### Preparation of Second Bed Catalyst with Ammonium Acetate Salt

The same procedure described in Example 2 was used to prepare the catalyst except that the exchange solution was made with ammonium acetate salt (14.48 g solid ammonium acetate and 912 cc DI water, initial pH was 6.8). The pH of the exchange solution was 6.5 after 4.5 minutes of ion-exchange. A 10% NH₄OH solution was used to keep pH between 8.0-8.5 during the exchange. The amount of 10% NH₄OH solution required to adjust pH was significantly reduced when compared with Example 2. The final catalyst has a Pt content of 0.01% by weight. The catalyst evaluation is described in Example 6.

### EXAMPLE 5

### Evaluation of Catalyst Prepared with Ammonium Nitrate Salt

A fixed bed reactor with ⅜″ external diameter was used for the evaluation. The reactor was equipped with a ⅛″ diameter thermal well to monitor reactor temperature at the center of the catalyst bed. The catalysts in the shape of cylindrical 1/16″ extrudate were loaded to the reactor based on the weight provided in Table 1.

TABLE 1

| Catalyst | Pt, wt % | Cat Wt, g |
|---|---|---|
| First bed, Example 1 | 0.03 | 0.5 |
| Second bed, Example 2 | 0.01 | 1.5 |

The reactor pressure was set at 225 psig with a steady flow of H₂ at 92 cc/min. The reactor temperature was increased at 0.833° C./min to 200° C., and held at 200° C. for 16 hours. The temperature was further increased at 0.833° C./min to 380° C., and held at 380° C. for 3 hours. The feed was introduced at 27.6 cc/hr (12 WHSV). This feed rate was maintained through the entire run. The feed composition is show in Table 2. The feed density was 0.87 g/cc.

TABLE 2

| Feed Component | Weight, % |
|---|---|
| Toluene | 0.59 |
| Ethylbenzene | 14.75 |
| O-Xylene | 18.24 |
| M-Xylene | 62.72 |
| P-Xylene | 2.51 |
| Propylbenzene | 0.01 |
| Isopropylbenzene | 0.04 |
| 1-Methy-3-ethylbenzene | 0.01 |
| 1-Methy-4-ethylbenzene | 0.01 |
| 1,4-Diethylbenzene | 0.01 |
| Other C10 Aromatics | 0.01 |
| C11 Aromatics | 1.13 |
| Total | 100.00 |

The reactor pressure was decreased to 185 psig, the H₂ flow was reduced to 82 cc/min, and reactor temperature was increased at 0.833° C./min to 430° C., and held at 430° C. for 24 hours.

The reactor pressure was increased to 225 psig, the H₂ flow was increased to 92 cc/min (1:1 H₂/HC molar ratio), and reactor temperature was reduced to 340° C., and held for 12 hours at 340° C. for data collection by online GC analysis. The reactor temperature was further increased at 0.833° C./min to 355, 370, 385, and 400° C. consecutively and held for 12 hours at each temperature setting for data collection by online GC analysis. This run was designated as B360. The results obtained at EB conversion of 64, 75, and 85% are shown in Table 4.

### EXAMPLE 6

### Evaluation of Catalyst Prepared with Ammonium Acetate Salt

The same procedure described in Example 5 was followed to evaluate the second set of catalysts described in Table 3. This run was designated as B361. The results obtained at EB conversion of 64, 75, and 85% are shown in Table 4.

TABLE 3

| Catalyst | Pt, wt % | Cat Wt, g |
|---|---|---|
| Top Bed, Example 3 | 0.03 | 0.5 |
| Bottom Bed, Example 4 | 0.01 | 1.5 |

Table 4 shows the micro unit results at EB conversion at 64, 75, and 85%. The data show that the performances of the two sets of catalysts are comparable for EB conversion and xylene isomerization.

TABLE 4
Comparison of Catalyst Performance

| | | Catalyst | | | | | |
|---|---|---|---|---|---|---|---|
| | | Prepared with NH₄NO₃ solution | | | Prepared with NH₄Ac solution | | |
| | | Example 5 | | | Example 6 | | |
| | | Run number | | | | | |
| | | B360 | | | B361 | | |
| Sample number | | 9 | 12 | 15 | 9 | 12 | 15 |
| Temperature, ° C. | | 367 | 382 | 397 | 368 | 382 | 397 |
| Temperature, ° F. | | 693 | 720 | 747 | 694 | 720 | 747 |
| Pressure, psig | | 226 | 216 | 213 | 217 | 213 | 203 |
| Feed flow rate, WHSV | | 12 | 12 | 12 | 12 | 12 | 12 |
| H₂/HC Molar ratio | | 1:1 | 1:1 | 1:1 | 1:1 | 1:1 | 1:1 |
| Time on Stream, hr | | 58.5 | 70.5 | 82.5 | 58.5 | 70.5 | 82.5 |
| EB Conversion, % | | 63.8 | 75.7 | 85.4 | 64.1 | 74.1 | 83.2 |
| Product Distribution, wt % | (feed) | | | | | | |
| H₂ | 0.00 | −0.20 | −0.24 | −0.27 | −0.21 | −0.24 | −0.25 |
| C₅_{^{−}} (light hydrocarbons) | 0.00 | 2.82 | 3.40 | 3.89 | 2.86 | 3.33 | 3.64 |
| C₆⁺ Non-aromatics | 0.00 | 0.43 | 0.39 | 0.35 | 0.46 | 0.44 | 0.38 |
| C₉⁺ Aromatics | 1.19 | 1.01 | 1.05 | 1.24 | 0.95 | 1.00 | 1.18 |
| Benzene | 0.00 | 6.31 | 7.47 | 8.44 | 6.18 | 7.36 | 8.32 |
| Toluene | 0.59 | 1.78 | 2.25 | 3.06 | 1.77 | 2.18 | 2.89 |
| p-Xylene | 2.51 | 19.39 | 19.51 | 19.38 | 19.68 | 19.67 | 19.53 |
| o-Xylene | 18.24 | 18.36 | 18.47 | 18.45 | 18.39 | 18.50 | 18.55 |
| m-Xylene | 62.72 | 44.77 | 44.11 | 43.31 | 44.62 | 43.93 | 43.29 |
| EB | 14.75 | 5.33 | 3.59 | 2.15 | 5.30 | 3.82 | 2.47 |
| Total | 100.0 | 100.0 | 100.0 | 100.0 | 100.0 | 100.0 | 100.0 |
| p-Xyl. + m-Xyl. | 65.23 | 64.16 | 63.63 | 62.69 | 64.30 | 63.60 | 62.81 |
| Total Xylenes | 83.47 | 82.52 | 82.10 | 81.14 | 82.69 | 82.10 | 81.36 |
| C₂/C₂⁼, Molar ratio | | 2148 | 2633 | 3070 | 2172 | 2554 | 2858 |
| Xylene loss ¹, wt % | | 1.14 | 1.64 | 2.79 | 0.93 | 1.63 | 2.52 |
| Ring loss ², mole % | | 0.44 | 0.44 | 0.40 | 0.53 | 0.48 | 0.28 |
| PXAE ³ | | 99.3 | 100.9 | 101.7 | 100.8 | 101.8 | 102.3 |
| Benzene Sel. from EB ⁴, % | | 90.7 | 90.6 | 90.8 | 89.6 | 91.1 | 91.8 |

Note in Table 4 the following:
¹ Xylene loss = 100 × (feed xylene − product xylene)/feed xylene;
² Ring loss = 100 × (total aromatic carbon in feed − total aromatic carbon in products)/total aromatic carbon in feed;
³ p-Xylene approaching equilibrium; and
⁴ Benzene Selectivity from EB = 100 × (Product benzene − Feed benzene)/(Feed EB − Product EB).

While the illustrative embodiments of the invention have been described with particularity, it will be understood that various other modifications will be apparent to and can be readily made by those skilled in the art without departing from the spirit and scope of the invention. Trade names used herein are indicated by a ™ symbol or ® symbol, indicating that the names may be protected by certain trademark rights, e.g., they may be registered trademarks in various jurisdictions. All patents and patent applications, test procedures (such as ASTM methods, UL methods, and the like), and other documents cited herein are fully incorporated by reference to the extent such disclosure is not inconsistent with this invention and for all jurisdictions in which such incorporation is permitted. When numerical lower limits and numerical upper limits are listed herein, ranges from any lower limit to any upper limit are contemplated.

What is claimed is:

1. In the method of making a metal-containing zeolite catalyst by competitive ion exchange, the improvement comprising preparation of said metal-containing zeolite catalyst by competitive ion exchange in the presence of ammonium acetate.

2. The method according to claim 1, wherein said zeolite is selected from at least one of ZSM-5, ZSM-11, ZSM-12, ZSM-18, MCM-68, MCM-22, Beta, mordenite, and mixtures thereof.

3. The method according to claim 1, wherein the metal in said metal-containing zeolite comprises at least one metal from Groups 8-10 of the Periodic Table.

4. The method according to claim 1, wherein said metal-containing zeolite includes at least one of platinum or rhenium dispersed in the amount of from 0.01 wt % to 1.20 wt %, preferably 0.01 wt % to less than 1.00 wt %, more preferably 0.01 wt % to 0.50 wt %, based on the weight of said metal-containing zeolite.

5. The method according to claim 1, wherein said metal-containing zeolite is silicone-selectivated.

6. The method according to claim 1, wherein said catalyst includes a support selected from alumina, silica, clay, aluminosilicates, and mixtures thereof.

7. A catalyst made by the process according to claim 1.

8. The catalyst made by the process of claim 7, further comprising an acetate moiety.

9. A catalyst system including a first bed comprising a first metal-containing zeolite catalyst adapted for dealkylation of ethylbenzene and ethylene saturation, and a second bed comprising a second metal-containing zeolite catalyst, different from said first catalyst and adapted for xylene isomerization, wherein at least one of said first catalyst and said second catalyst is prepared by competitive ion exchange in the presence of ammonium acetate.

10. The catalyst system according to claim 9, wherein at least one of said first catalyst and said second catalyst comprise a zeolite selected from ZSM-5, ZSM-11, and mixtures thereof.

11. The catalyst system according to claim 9, wherein the metal in said metal-containing zeolite comprises at least one metal from Groups 8-10 of the Periodic Table.

12. The catalyst system according to claim 9, wherein said metal-containing zeolite includes at least one of platinum or rhenium dispersed in the amount of from 0.01 wt % to 1.20 wt %, preferably 0.01 wt % to less than 1.00 wt %, more preferably 0.01 wt % to 0.50 wt %, based on the weight of said metal-containing zeolite.

13. The catalyst system according to claim 9, wherein at least one of said metal-containing zeolite is silicone-selectivated.

14. A process for the production of paraxylene comprising contacting a C8 aromatic hydrocarbon paraxylene-depleted feedstock including ethylbenzene and xylenes with a first catalyst comprising a metal-containing silicone-selectivate zeolite catalyst to obtain an intermediate feed characterized as being ethylbenzene-depleted as compared with said paraxylene-depleted feedstock, then contacting said intermediate feed with a second catalyst, different from said first catalyst and comprising a metal-containing zeolite catalyst, to obtain a paraxylene-enriched product, when compared with said paraxylene-depleted feedstock, the improvement comprising the production of at least one of said first catalyst and said second catalysts by a process including competitive ion exchange wherein ammonium acetate is used in said process.
